(19) United States
(12) Patent Application Publication
(10) Pub. No.: US 2008/0281692 A1
(43) Pub. Date: Nov. 13, 2008

(54) Virtual Points Clearinghouse

(75) Inventors: Junbo Zhang, Redmond, WA (US); Tony Ying-Kin Yip, Kirkland, WA (US); Jacky Xugang Wang, Shanghai (CN); Jason Zhiqing Hong, Shanghai (CN); Shu Zhang, Shanghai (CN)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/747,104

(22) Filed: May 10, 2007

(51) Int. Cl. G06Q 30/00; G06Q 90/00

(52) U.S. Cl. 705/14; 705/39

(57) ABSTRACT

Systems and methods establish a virtual points clearinghouse. The clearinghouse redeems heterogeneous digital micro-payments-such as bonus points received from various points issuers-across diverse service providers. Points meant for exclusive redemption at one service provider may be directly redeemed for non-corresponding goods of a different service provider. In one implementation, the clearinghouse includes contracts between points issuers, service providers, and a clearinghouse, including intervening conversion rates. A user interface enables a user to manage multiple point balances from a computing device, cell phone, or other mobile device. The user interface enables the user to find diverse goods and to directly obtain the goods by redeeming diverse heterogeneous points. The clearinghouse includes an invoicing engine to enable money flow between users, points issuers, service providers, and the clearinghouse.

### BACKGROUND

Currently, there are many different virtual bonus points and credits available over the Internet, such as airline miles, ICOKE points, MICROSOFT points, YAHOO points, QQ coins, mobile phone minutes, coupons, advertising discount codes, etc. These various points, bonuses, and credits are referred to interchangeably herein both as “points” and as “digital micro-payments” depending on the context. Digital micro-payments or points are not issued in the form of cash or currency of any country or government.

One characteristic of points is that they are conventionally limited in their issuance and their redemption to a single service provider, such as a business entity, a company, corporation, advertiser, etc. As shown in FIG. 1, a first points issuer 102, a second points issuer 104, and an “nth” points issuer 106 each award a type of points to a user 108. A given points issuer may or may not be the same entity as the service provider that redeems the points for a product or service. A given merchant may “team up” with an unrelated service provider to issue points accepted by the service provider. For example, by reserving a room at a hotel, one may earn airline miles according to a contract established between the hotel and the airline. But once issued, each type of point conventionally has an exclusive redemption that is limited to the goods of a single intended service provider (e.g., 110). Users who obtain these digital micro-payments can conventionally only redeem them—without a cumbersome conversion or exchange—for goods or services provided by the corresponding digital micro-payment issuers. Conventionally, a user can only redeem ICOKE points for the products or services offered on a COKE website.

Currently in the U.S. there are some conventional services that enable users to convert, exchange, or swap their bonus points and credits. But the conversion must be done manually and individually for each transaction, and the product or service to be obtained must be still be redeemed by the corresponding type of points. For example, www.points.com enables users to convert their awarded AMERICAN airline miles to NORTHWEST airline miles. But this service does not enable the user to directly obtain a NORTHWEST airline ticket with AMERICAN miles. Additionally, the exchange program is very limited.

In another conventional exchange scenario, when a user redeems miles or points, the user does not directly receive gift cards or certificates for various merchants of the redeemable products and services, much less to the products or services themselves. Instead, the user receives a reward that can be exchanged, online, for gift cards and certificates-but only in preset denominations, such as $10, $15, $20, $25, $50, $100, $250, $500, $750, $1000, etc. When the user's redemption transaction completes, the user receives an e-mail with a link to the exchangeable reward. This e-mail typically takes three to five days to arrive. Once the email arrives, the user follows the instructions to choose gift cards and certificates. Then, after selecting a gift card or certificate, it is printed and shipped to the address specified by the user. The amount of time this takes can vary-normal shipping takes 7-10 business days.

Moreover, typically the gift cards or certificates cannot be returned or exchanged. They cannot be reissued if expired, lost, or stolen. They are fulfilled only to the address supplied on the award redemption form. The broker is not responsible for lost certificates as a result of non-delivery due to incorrect or illegible addresses or other occurrences outside of their control, etc.

Further, service providers and product vendors of the goods to be redeemed typically do not have a payment gateway for directly charging a user's points, especially points that are not issued by that service provider. There are some payment techniques, such as a FIRST DATA CORPORATION gateway, that enable service providers to collect money from users. (FDC, Greenwood Village, Colo.). But this is limited to real currency. There is no payment gateway for digital micro-payments.

### SUMMARY

Systems and methods establish a virtual points clearinghouse. The clearinghouse redeems heterogeneous digital micro-payments-such as bonus points received from various points issuers-across diverse service providers. Points meant for exclusive redemption at one service provider may be directly redeemed for non-corresponding goods of a different service provider. In one implementation, the clearinghouse includes contracts between points issuers, service providers, and a clearinghouse, including intervening conversion rates. A user interface enables a user to manage multiple point balances from a computing device, cell phone, or other mobile device. The user interface enables the user to find diverse goods and to directly obtain the goods by redeeming diverse heterogeneous points. The clearinghouse includes an invoicing engine to enable money flow between users, points issuers, service providers, and the clearinghouse.

This summary is provided to introduce the subject matter of a virtual points clearinghouse, which is further described below in the Detailed Description. This summary is not intended to identify essential features of the claimed subject matter, nor is it intended for use in determining the scope of the claimed subject matter.

### BRIEF DESCRIPTION OF THE DRAWINGS

FIG. 1 is a diagram of a conventional scenario for redeeming digital micro-payments.

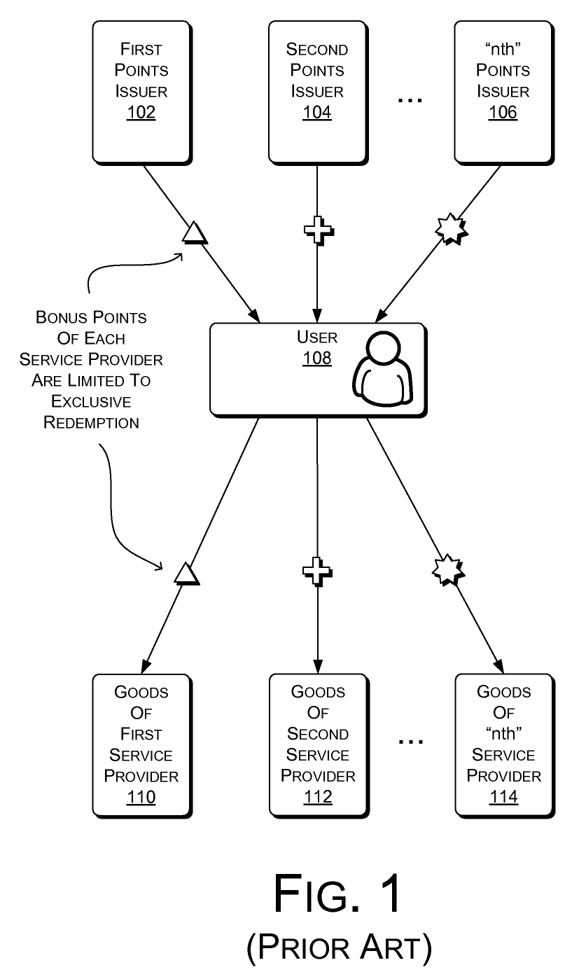

FIG. 2 is a diagram of an exemplary clearinghouse for redeeming digital micro-payments across different service providers.

FIG. 3 is diagram of an exemplary system for redeeming digital micro-payments.

FIG. 4 is a block diagram of the exemplary clearinghouse of FIGS. 2 and 3, in greater detail.

FIG. 5 is a diagram of exemplary contract formation and money flow in redeeming digital micro-payments from various points issuers across different service providers.

FIG. 6 is a diagram of exemplary interactions when redeeming digital micro-payments via an exemplary clearinghouse.

FIG. 7 is a diagram of exemplary interactions when redeeming digital micro-payments via a service provider.

FIG. 8 is screen shot of an exemplary user interface for managing a user account for redeeming digital micro-payments across different service providers.

FIG. 9 is a screen shot of an exemplary user interface for purchasing a good by selecting non-corresponding points.

FIG. 10 is a screen shot of an exemplary user interface for confirming a purchase performed by redeeming digital micro-payments across different service providers.

FIG. 11 is a screen shot of an exemplary user interface for viewing a history of changes within a user account of multiple point balances.

FIG. 12 is a flow diagram of an exemplary method of redeeming heterogeneous digital micro-payments from various points issuers across different service providers.

### DETAILED DESCRIPTION

Overview

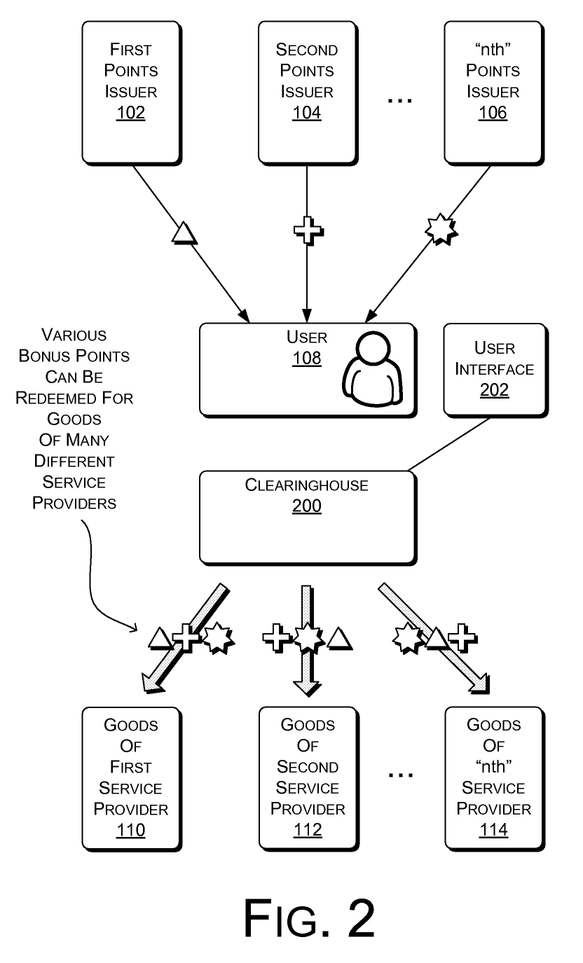

This disclosure describes systems and methods for implementing an exemplary virtual points clearinghouse. As shown in FIG. 2, an exemplary scenario allows the user 108 to directly redeem virtual bonus points and credits obtained from various “points issuers” (e.g., 102, 104, 106) for diverse products and services (e.g., 110, 112, 114) selected from a “supermarket” of different participating providers-instead of redeeming points only for products and services offered by the same entity that issued the points. The exemplary scenario avoids the trouble and delay of manually discovering which types of points can be exchanged and manually converting between types of points for each individual transaction. The exemplary scenario allows users to directly and immediately redeem points for products and services that do not correspond to the products and services of the points issuer. Through the exemplary clearinghouse 200 and user interfaces 202 described herein, various products and services can be obtained directly and immediately by redeeming corresponding or non-corresponding points.

As introduced above, virtual points and other bonuses such as airline miles are referred to herein as “digital micro-payments” or just “points” in some contexts. “Virtual” in the present context just means that the points are digital and/or electronic, not dependent on a physical artifact, such as cash. For example, a point or digital micro-payment can be a purchase point, referral point, reward point, bonus point, airline mile, mobile phone minute, coupon discount, promotional discount, discount code, or other virtual credit that is capable of being issued to a user or participant of a good or service, and that is not in the form of cash or a currency of any country or government.

“Digital micro-payment issuer”—a points issuer that is typically, but not always a goods provider—refers to an entity that issues points, bonuses, credits, promotional discounts, etc. Usually the digital micro-payment issuer is the same entity as the provider of the goods or service obtainable by redeeming the issued points. For example, ALASKA airlines issues ALASKA airline miles in an ALASKA AIRLINES MILEAGE PLAN. The exemplary clearinghouse, however, enables the digital micro-payments issuer and the service provider accepting redemption to be different.

“Service provider” refers to an entity that offers a “good” (i.e., a product or service) in exchange for a corresponding redemption of a predetermined type of digital micro-payment. As just mentioned, the digital micro-payment issuer and the service provider are conventionally one and the same-as the points are typically issued to promote a product or service. The exemplary clearinghouse, however, enables the digital micro-payments issuer and the service provider to be different as a matter of course.

In one implementation, the exemplary system to be described herein includes the exemplary clearinghouse that accepts numerous types of digital micro-payments in order to enable the user to directly and immediately obtain various types of products and services that do not necessarily correspond to the products and services of the points issuer. The exemplary clearinghouse also provides common/standard interfaces, e.g., for merchants to charge users.

Exemplary System

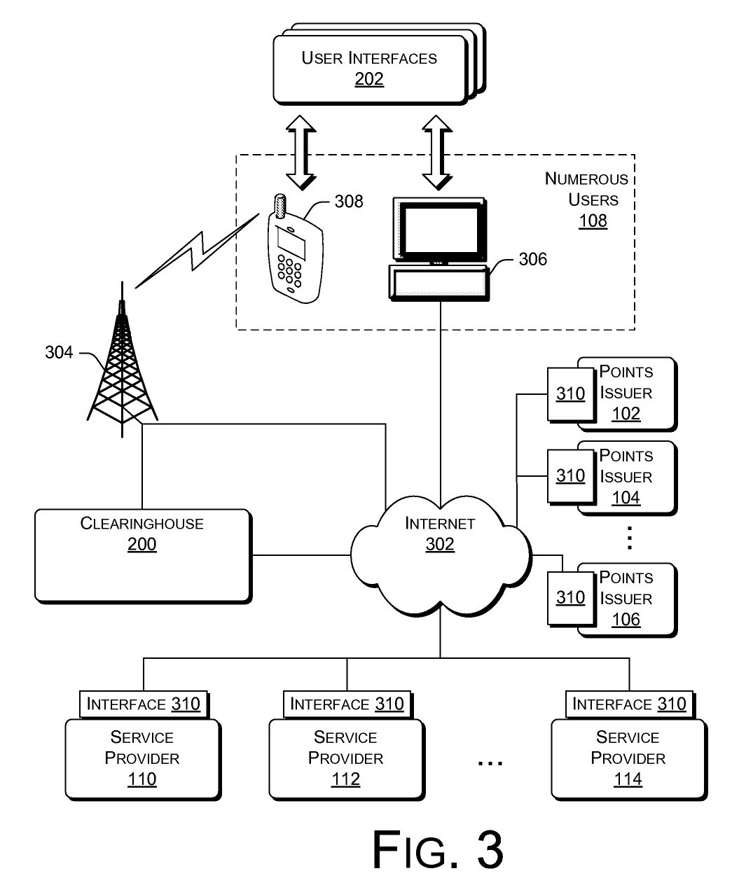

FIG. 3 shows an exemplary system 300 for redeeming digital micro-payments. One or more users 108 connect with the Internet 302 or to another communication network, such as a telephone network and/or a wireless network 304 via a computing device 306 or a mobile communication device 308, such as a cell phone, mobile computer, pocket PC, smart phone, etc. The exemplary clearinghouse 200 is also communicatively coupled with the Internet 302 and other communications channels, such as wireless networks 304, mobile phone services, etc. Points issuers (102, 104, 106) and service providers (e.g., 110, 112, 114) are also coupled with the Internet 302 via interfaces 310, which in one implementation may be interfaces 310 compatible with the exemplary clearinghouse 200 according to a clearinghouse standard. Through the interface 310, points issuers (e.g., 102) and goods providers (e.g., 112) communicate with and execute transactions through the exemplary clearinghouse 200 and may also communicate and transact with users 108.

The exemplary clearinghouse 200 may also include various user interfaces 202 deployed at the user's side and suited to the user's devices (e.g., 306, 308). The user interfaces 202 facilitate secure communication, and are used for redeeming points and managing user accounts, including balances of various digital micro-payment accounts under the same user 108.

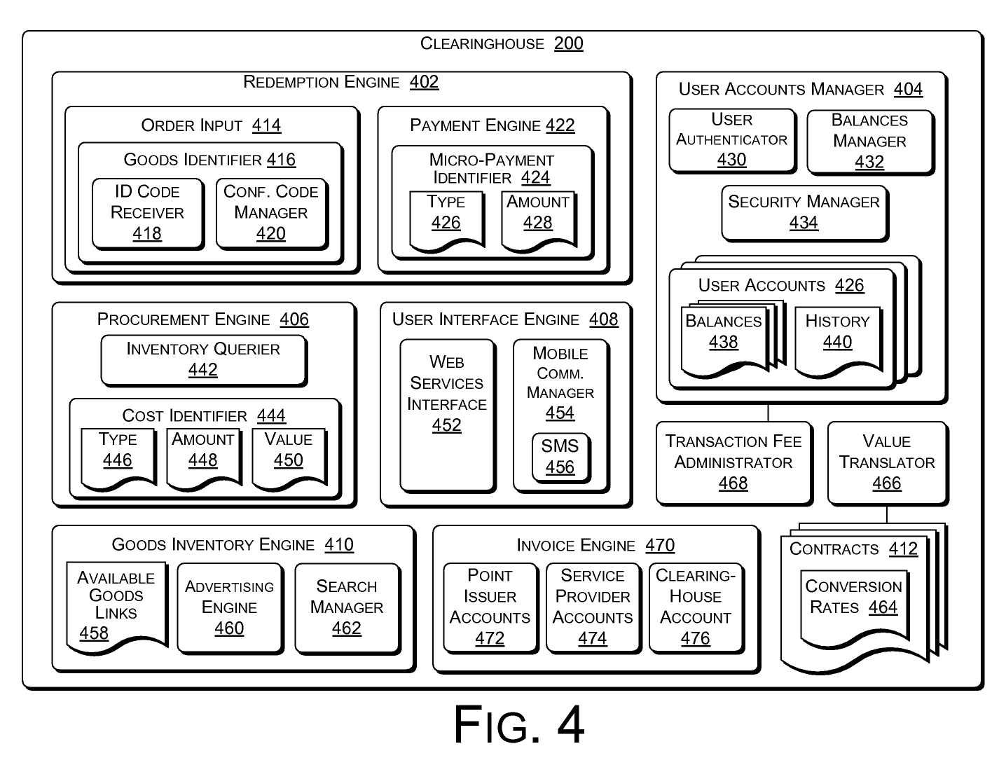

FIG. 4 shows the exemplary clearinghouse 200 of FIGS. 2 and 3 in greater detail. The illustrated implementation is one example configuration, for descriptive purposes. Many other arrangements of the components of an exemplary clearinghouse 200 are possible within the scope of the subject matter. Such an exemplary clearinghouse 200 can be executed in combinations of hardware, software, firmware, etc.

The illustrated clearinghouse 200 serves numerous users 108 and numerous service providers 102. The clearinghouse 200 includes a redemption engine 402, a user accounts manager 404, a procurement engine 406, a user interface engine 408, a goods inventory engine 410, and contracts 412 between various service providers 102 and/or between one or more service providers 102 and the exemplary clearinghouse 200.

The redemption engine 402 may further include an order input 414, which further includes a goods identifier 416 with an identifying code receiver 418 and a confirmation code manager 420; and a payment engine 422 that may further include a micro-payment identifier 424 to identify a type 426 and an amount 428 of a micro-payment.

The user accounts manager 404 may further include a user authenticator 430, a balances manager 432, a security manager 434 for protecting account transactions and changes; and user accounts 436, including points balances 438 and transaction histories 440.

The procurement engine 406 may further include an inventory querier 442, and a cost identifier 444 to determine a type 446 and an amount 448 of points needed to be redeemed to obtain a good, and/or a value 450 of the good.

The user interface engine 408 may further include a web services interface 452, and a mobile communications manager 454, including, for example, a short messaging service agent (SMS) 456 for text messaging.

The goods inventory engine 410 may further include available goods links 458-i.e., links to available goods and services to be obtained by redeeming points; an advertising engine 460, and a search manager 462.

The contracts 412 may specify conversion rates 464 between types of digital micro-payments and goods and may contain other agreements regarding scope, revenue sharing rules, etc., between service providers 102 and the clearinghouse 200.

The clearinghouse 200 includes a value translator 466 that is based on the contracted conversion rates 464 for converting costs in one type of digital micro-payment into a corresponding cost in another type of digital micro-payment.

If revenue sharing rules in the contracts 412 call for fees to be extracted from transactions or if maintenance of the clearinghouse 200 is based on a fraction of value of redeemed points (i.e., instead of determined in some non-transaction-based manner by the contracts 412), then the clearinghouse 200 may include a transaction fee administrator 468 and charge service fees. Also, a first points issuer 102 may charge a tiny surcharge of points for redeeming the points of a second points issuer 104, as specified in a contract 412 between the first points issuer 102, the second points issuer 104, and the clearinghouse 200.

In one implementation, the clearinghouse 200 also includes an invoice engine 470. The invoice engine 470 tracks point flow and redemption to enable real money exchange between users 108, points issuers 102, service providers 110, and the clearinghouse 200. The invoice engine 470 may further include point issuer accounts 472, service provider accounts 474, and a clearinghouse account 476. The invoice engine 470 has access to the user accounts 426, including point balances 438 and histories 440, in order to track users' transaction histories 440 including point redemption and refilling. The money flow is described in greater detail below.

Operation of the Exemplary System

From the standpoint of a merchant or service provider 102 offering goods 110, the service provider 102 can accept more types of digital micro-payments through the exemplary clearinghouse 200. From the standpoint of a user 108, the user 108 enjoys a variety of digital micro-payment types to obtain many different kinds of products and services not associated with the service providers 102 that issued their respective digital micro-payments. This increases the effective value each type of digital micro-payment, because each type may be used to obtain many more types of goods. Each user 108 has a larger scope for redeeming points. For example, a can of COKE can conventionally be redeemed only by 10 ICOKE points. The exemplary clearinghouse 200 may enable the user 108 to use 15 MICROSOFT points (hypothetical example) to redeem the same can of COKE. The hypothetical redemption rate that 10 ICOKE points equal 15 MICROSOFT points would be agreed on by COKE and MICROSOFT in a contract 412.

The exemplary clearinghouse 200 enables users 108 to have a central platform to redeem various digital micro-payments for a vastly improved variety of goods, compared with conventional redemption scenarios. As a gateway, the exemplary clearinghouse 200 enables a service provider 102 to charge whatever points the user 108 has on hand in his user account 426, while users 108 have a one-stop location to obtain a variety of goods using their points.

Each service provider 102 may use a single interface 310 to the clearinghouse 200 to charge a myriad of different digital micro-payments. The service provider 102 does not have to implement a different interface for each different type of point to be redeemed. The clearinghouse 200 also assists the service provider 102 to collect more points.

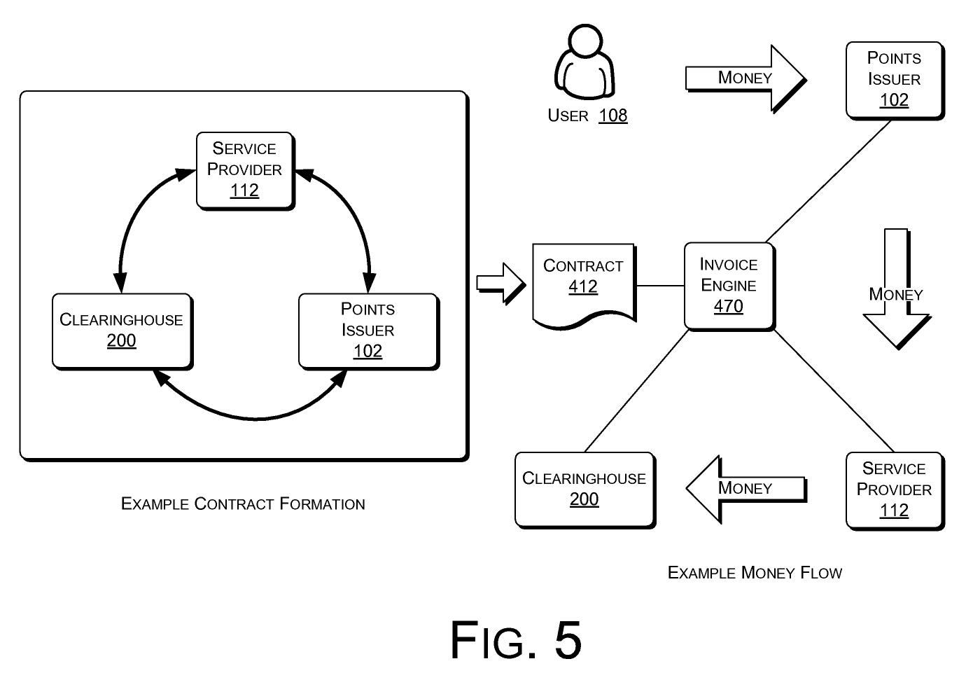

As shown in FIG. 5, in one implementation, before redemption transactions take place, a given service provider 112, a given digital micro-payments issuer—the points issuer 102-and the exemplary clearinghouse 200 create a contract 412. The clearinghouse 200 may keep many such contracts 412. Each contract 412 may include revenue sharing rules, conversion rates, and common interfaces to be used as well as the scope of the contract—including which goods and points are covered.

The contract 412 includes conversion rates 464, i.e., between the type of digital micro-payments issued (e.g., by a points issuer 102) and the type of goods capable of being redeemed (e.g., by a second service provider 112). The value translator 466 of the clearinghouse 200 can use these conversion rates 464 to enable the direct redemption of goods that do not correspond to the type of points issued. The clearinghouse 200 may exact a transaction fee or service fee as part of the contract 412, and in one implementation collection of such service fees is executed by the transaction fee administrator 468 associated with the user accounts manager 404. As introduced earlier, conversion rates 464 also allow conversion between different types of points (e.g., a hypothetical conversion rate of 15 MICROSOFT points for 10 ICOKE points); and/or between a type of point and a currency (e.g., hypothetical conversion rate of 95 MICROSOFT points=$0.95 U.S. dollars).

In FIG. 5, the invoice engine 470 uses parameters established in the contracts 412 to enable real money flow between users 108, points issuers (e.g., 102), service providers (e.g., 112), and the clearinghouse 200. The invoice engine 470 tracks history (settlement) of a user's point redemption and refilling, e.g., based on the balances 438 and the history 440 in a user's account 426. The service provide 112 and the points issuer 102 can use the invoice engine 470 to pay real money to each other. For example, in a typical transaction, real money may move from the user 108, to the points issuer 102, to the service provider 112, and to a clearinghouse account 467 (for service fees and transaction fees according to the contracts 412). The invoice engine 470 of the clearinghouse 200 can mediate some or all of these real money transactions. For example, the points issuer 102, service provider 112, and clearinghouse 200 may pay each other in real money according to the records of the invoice engine 470. In one implementation, the invoice engine 470 may send periodic invoices to points issuers 102 and service providers 112. The clearinghouse 200 may also mediate payment of these invoices between all parties involved.

In a typical redemption transaction, the user 108 selects goods 112 to obtain and selects points to redeem for the transaction via the user interface 202. Different user interfaces 202 may be employed depending on whether the user 108 is transacting through a computing device 306, through a mobile communications device 308, or through some other device. Example user interfaces 202 will be described in greater detail below.

The redemption engine 402 receives the user's 108 communication at the order input 414, where the goods identifier 416 signals the goods inventory engine 410 in order to identify the product or service selected by the user 108. In one implementation, the user 108 is only exposed to those goods that can be redeemed through the clearinghouse 200, while in another implementation the user 108 is free to enter any good, and the clearinghouse 200 consults the goods inventory engine 410 to determine if the proposed good is redeemable through the clearinghouse 200.

In one implementation, the goods identifier 416 can receive an identity code 418 of the desired good. The identity code 418 may be a string of alphanumeric characters entered from a website into the user's 108 user interface 202, or may be keyed in by the user 108 on the keypad of the computing device 306 or mobile communication device 308. The identity code may also be a visual code 418, such as a QR code that the user 108 captures with a cell phone camera and transmits to the identity code receiver 418. In one implementation, the identity code receiver 418 converts the QR code image into a string that identifies the product or service. In one implementation, a confirmation code manager 420 returns a code to the user 108 to verify the user 108 and/or the product 110. For example, the confirmation code manager 420 may send a code to the user's 108 mobile device 308 by SMS 456. The user 108 then enters the received code into the user interface 202 to complete the confirmation.

The payment engine 422 of the redemption engine 402 has a micro-payment identifier 424 that determines the type 426 and the amount 428 of the digital micro-payments to be redeemed by the user 108 to complete the transaction. The type 426 of points to be redeemed may depend on the user's 108 account 436, and more specifically on which type of points the user 108 has designated as highest priority for being redeemed first, i.e., when there are several types of point balances 438 in the user's account 436. It may be that the user 108 does not know how many of a given type of point to pay for a selected good. In such a case, the micro-payment identifier 424 may retrieve or calculate the amount 428 of points needed to complete a transaction-in a given denomination of points-and return the amount 428 for display on the user interface 202. The micro-payment identifier 424 can request the procurement engine 406 to obtain the cost of a good in a given denomination of points.

In one implementation, the procurement engine 406 includes an inventory querier 442 that searches a database of information about the goods. A cost identifier 444 can retrieve or calculate the cost of a good, i.e., in an amount of a particular type of points. A good may be advertised as costing a certain amount of a particular type of points, in which case the cost identifier 444 may return a type 446 and an amount 448 of points. Or, the cost identifier 444 may access information about the underlying value 450 of a good in units adopted as standard by the clearinghouse 200, and from this underlying value 450 calculate an amount 448 of points needed for a given denomination or type 446 of points. In one implementation, the value translator 466 translates the underlying value of a good into a particular denomination of points, using the conversion rates 464 in the contracts 412. Or, the value translator 466 may convert directly between different types of points using the conversion rates 464 (without resorting to the underlying value of the good stored in a database of information about the good).

The goods inventory engine 410 may compile a list of links to available goods 458 that the advertising engine 460 can post to a user interface 202. In one implementation, when the user 108 wants to procure a certain good, the advertising engine 460 sends the user 108 to a webpage of such goods that can be obtained by points redemption. The advertising engine 460 may offer more detailed pages describing goods when the user clicks or selects one of the available goods links 458. The advertising engine 460 may also post a list of friends or buddies on the user interface 202, who have purchased a type of good that the user 108 is considering for purchase.

The goods inventory engine 410 may also include a search manager 462 accessible from the user interface 202. That is, the user 108 may search from his computing device 306 or mobile device 308 to find a good to obtain.

When the redemption engine 402 has identified the good to be obtained and has identified the types 426 and amounts 428 of digital micro-payments needed to complete the redemption, then the points are withdrawn from the balances 438 in the user's account 436. Multiple types of points may be redeemed in the same transaction.

In one implementation, the user accounts manager 404 allows the user 108 sophisticated and comprehensive control over his user account 436. First, a user authenticator 430 secures the identity of the user 108. For example, a user 108 may submit a password into the user interface 202 on a mobile device 308 to gain access to his user account 436. The user 108 can program the balances manager 432 to administer the balances 438 of various points in the user account 436. The user 108 can designate a priority for each balance 438 of points in the account 436. For example, the user 108 may specify that in a redemption transaction, MICROSOFT points are to be used first, followed by UNITED airline miles, followed by COKE points, followed by mobile phone minutes. Further, the user 108 can specify automatic minimum balances 438 and/or automatic balance refilling. That is, the user 108 may specify that when MICROSOFT points get below the level of 100 points, then mobile phone minutes in a different balance 438 are to be converted to MICROSOFT points at the contracted conversion rate 464 to keep the MICROSOFT points above a threshold minimum level. Or vice versa, the user 108 might specify that MICROSOFT points are to be converted to keep the mobile phone minutes above a pre-specified minimum. The user account 436 may also allow the user 108 to view a transactions history 440.

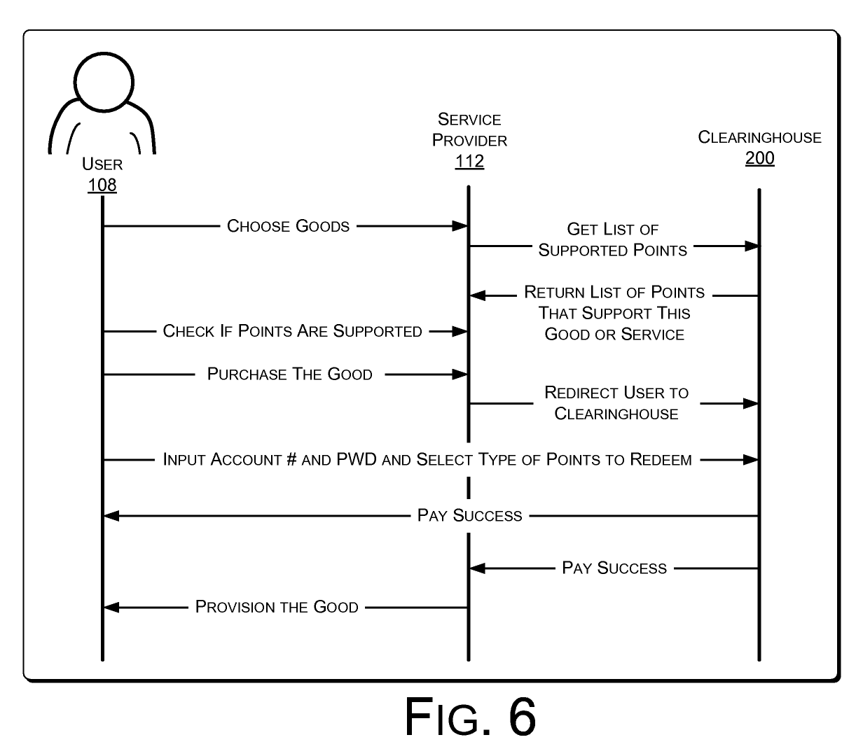

FIG. 6 shows an example redemption transaction. A service provider 112 redirects a user 108 to the exemplary clearinghouse 200 to input, for example, an account number and personal identification number (PIN). First, the user 108 selects a good to obtain. The service provider 112 requests a list of supported points from the clearinghouse 200. The clearinghouse 200 returns a list of points that support the good or service to the service provider 112. The user 108 checks with the service provider 112 to see if a particular type of point in his account 436 is redeemable for the good. The user 108 then initiates purchase of the good from the service provider 112, and the service provider 112 redirects the user 108 to the clearinghouse 200. The user 108 inputs an account number and password to the clearinghouse 200 and designates the type of point or other digital micro-payment to use in the redemption transaction. Upon payment success, the service provider 112 delivers the product or service.

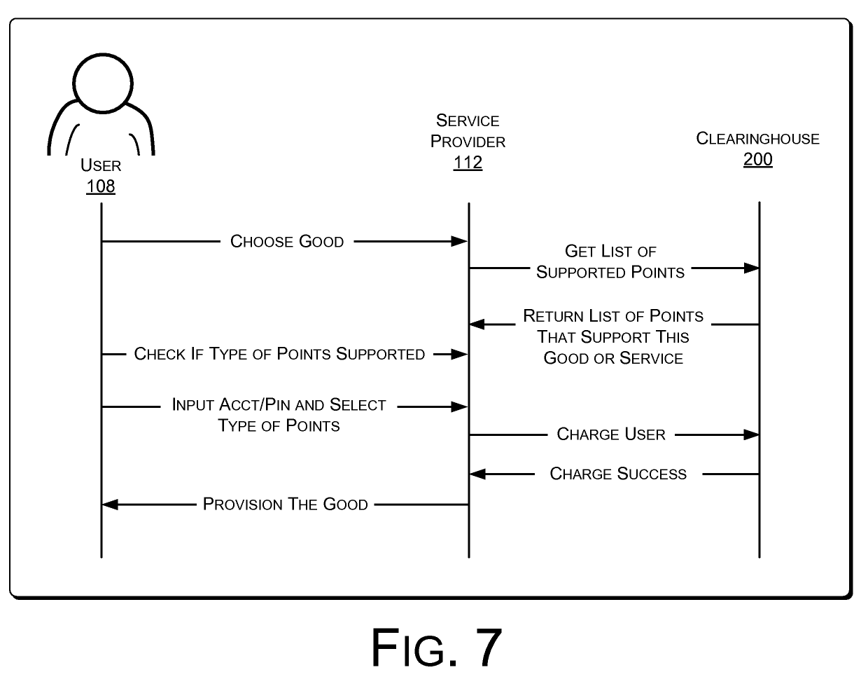

FIG. 7 shows another example redemption transaction. In this variation, the user 108 purchases directly from an account at the service provider 112, and the service provider 112 in turn charges the exemplary clearinghouse 200. First, the user 108 selects a good to obtain from the service provider 112. The service provider 112 requests a list of supported points from the clearinghouse 200. The clearinghouse 200 returns to the service provider 112 a list of points that support the good or service to be obtained. The user 108 then checks with the service provider 112 to see if a particular type of point or other digital micro-payment possessed by the user 108 is redeemable for the good. The user 108 inputs an account number and PIN of an account at the service provider 112 (not the user account 436 at the clearinghouse 200). The service provider 112 charges the user 108 via the clearinghouse 200. The clearinghouse 200 relays success of the charge to the service provider 112. The service provider 112 then delivers or provisions the good.

Referring again to FIG. 4, the user interface engine 408 may include interfaces and managers to facilitate redemption transactions across multiple communications platforms. In one implementation, the user interface engine 408 includes the web services interface 452 and the mobile communications manager 454. The web services interface 452 enables communication (over the Internet 302 or other network) with service providers (e.g., 102) and users 108. Various web services may be utilized to perform redemption transactions via the clearinghouse 200. For example, the clearinghouse 200 may host various websites accessible through a browser, or the clearinghouse 200 may leverage instant messaging (IM) for a user's computing device 306, cell phone 308, or other mobile device 308, etc. The mobile communications manager 454 facilitates communications with users 108 on their cell phones and other mobile devices 308, e.g., phone-based Internet, SMS, and/or phone-based instant messaging. Exemplary user interfaces 202 can be implemented on the various communications platforms to advertise to users 108, and to allow the users 108 to search for goods, to redeem points, and to manage their own user accounts 436 at the clearinghouse 200.

Exemplary User Interfaces

The user interface engine 408 can control numerous types of user interfaces 202 in order to achieve redemption transactions through the exemplary clearinghouse 200. Those described below are examples to show some user interfaces 202 that can be extended by the exemplary clearinghouse 200. The examples shown are not meant to portray a comprehensive set of user interfaces 202 for the clearinghouse 200, because a myriad of user interfaces 202 are usable with the clearinghouse 200. For example, user interfaces 202 are available for desktop computers, pocket PC's, PDAs, cell phones, smart phones, pocket controllers for managing a mobile device at a desktop computer, etc. Combinations can also be used, such as ordering a good via an Internet marketplace website participating with the clearinghouse 200, while receiving product and payment confirmation codes over an SMS service that is active on a cell phone.

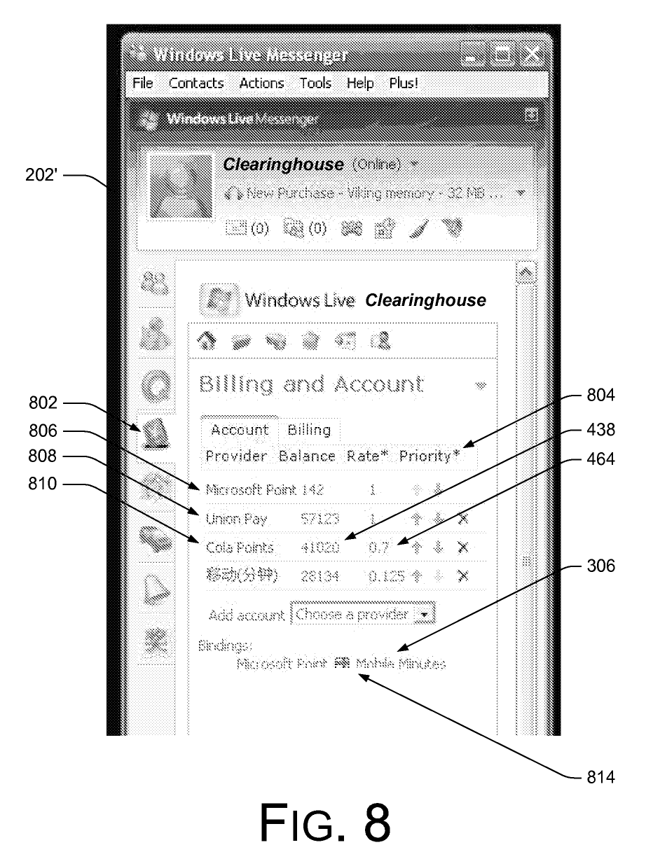

FIG. 8 shows an exemplary user interface 202′ associated with the user accounts manager 404 of FIG. 4. In a billing and account pane that can be accessed by selecting a visual tab 802, various digital micro-payment balances 438 are listed in order of priority 804. For example, MICROSOFT points 806 are designated as highest priority and will be redeemed first in a transaction, unless the user 108 specifically selects a different type of point for first redemption. UNION PAY 808 and COLA points 810 have second and third priorities, respectively. A balance 438 is shown for each type of point. Each type of point also has a conversion rate 464 with respect to some reference. The reference may be a designated type of point adopted as a standard, or may be some other benchmark of relative value. The user 108 may bind two different types of points or accounts together 812, and select a conversion direction 814. For example, in one conversion direction the balances manager 432 of the user accounts manager 404 automatically refills mobile minutes with converted MICROSOFT points 806 when the mobile minutes fall below a selected threshold.

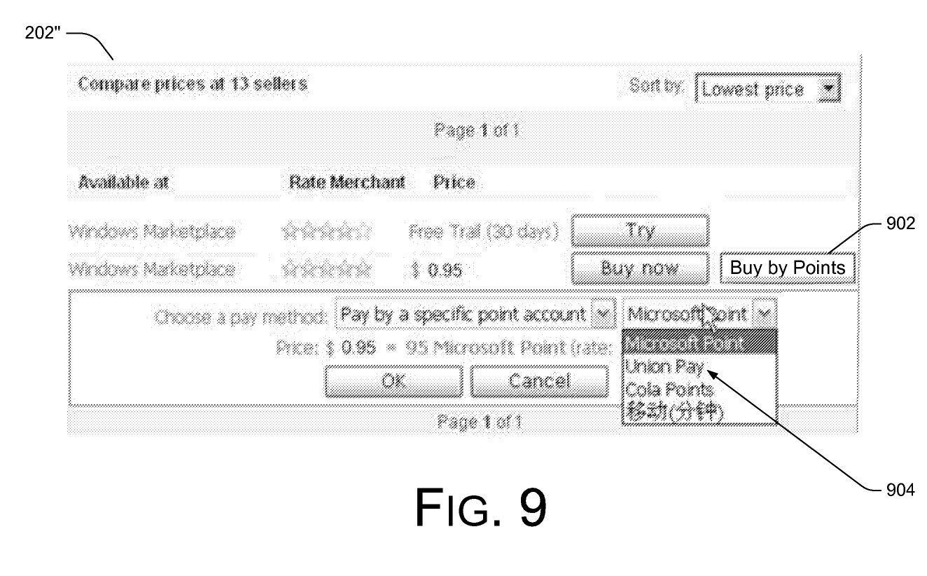

FIG. 9 shows an exemplary user interface 202″ associated with redemption transactions mediated by the redemption engine 402. In this user interface 202″, a given product can be purchased with cash or can be redeemed via the exemplary clearinghouse 200 by actuating a “buy by points” button 902 that transfers the transaction over to the exemplary clearinghouse 200. The micro-payment identifier 424 accepts a user selection 904 to determine the particular type of points to be redeemed in the transaction.

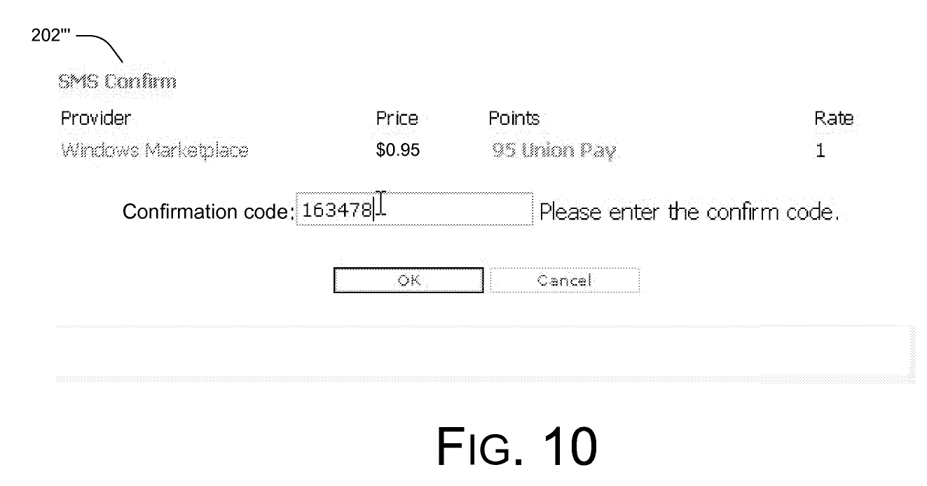

FIG. 10 shows an exemplary user interface 202′″ extended during operation of the confirmation code manager 420. In one implementation, the clearinghouse 200 sends a confirmation code by SMS 456 to complete a purchase. The user 108 receives the confirmation code, e.g., on a mobile phone 308, and enters the code into the user interface 202′″. The clearinghouse 200 then has the purchased good shipped to the user's residence or enables the user 108 to download the good via an online marketplace. A similar confirmation pane of the user interface 202′″ can also be used to confirm that the user 108 is adding a new type of points account/points balance 438 to his user account 436. Likewise, a similar user interface 202′″ can also be used for confirmations by the security manager 434 for verifying other changes in the user's account 436.

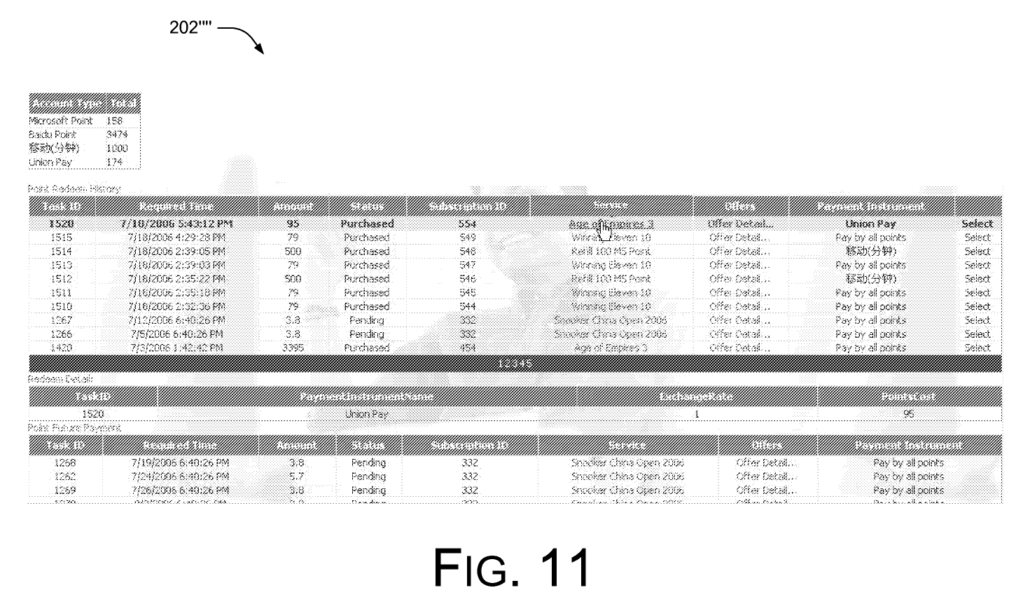

FIG. 11 shows an exemplary user interface 202″″ extended when the user selects a history 440 feature of the user accounts manager 404. In one implementation, the history user interface 202″″ comprehensively depicts changes in the user's account 436, including point redemptions, point refills, and rebalancing of various point balances 438.

Exemplary Methods

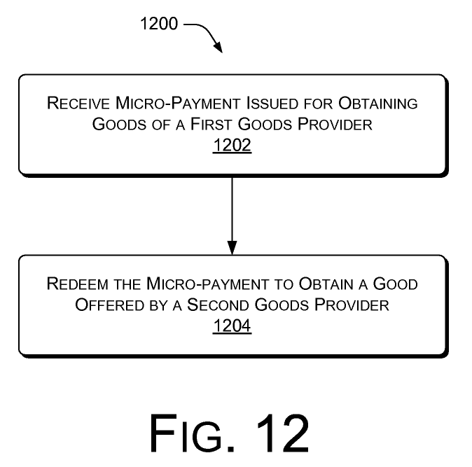

FIG. 12 shows an exemplary method 1200 of redeeming heterogeneous digital micro-payments from various points issuers across different service providers. In the flow diagram, the operations are summarized in individual blocks. The exemplary method 1200 may be performed by hardware, software, or combinations of hardware, software, firmware, etc., for example, by components of the exemplary clearinghouse 200.

At block 1202, a micro-payment issued for obtaining goods of a first goods provider is received. Such digital micro-payments, such as bonus points, airline miles, and other non-cash credits, are typically issued by a points provider for exclusive redemption at a specific service provider. In other words, the bonus points are meant to be redeemed only for intended products and services associated with the bonus points.

At block 1204, the micro-payment is redeemed to obtain a good offered by a different service provider than the service provider intended by the points issuer. In one implementation, since the micro-payments are typically issued for exclusive redemption to obtain intended goods, the exemplary method 1200 includes creating contracts between points issuers, service providers, and a clearinghouse in order for the points issuers and the service providers to accept each other's micro-payments. The contracts may also include conversion rates between points and services or even between the different denominations of micro-payments of each participating service provider. The exemplary method 1200 not only includes redeeming heterogeneous micro-payments for non-intended goods, but in various implementations also includes enabling the user to prioritize and charge goods to multiple bonus point balances, e.g., within a user account at the exemplary clearinghouse.

Conclusion

Although exemplary systems and methods have been described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A method, comprising:
forming a contract between a micro-payment issuer and a second goods provider, wherein the micro-payment issuer issues micro-payments redeemable only for a first good of a first goods provider;
receiving a micro-payment redeemable only for the first good of the first goods provider; and
redeeming the micro-payment to obtain a second good offered by the second goods provider.

2. The method as recited in claim 1, wherein forming the contract includes obtaining an agreement between the micro-payment issuer and the second goods provider for the second goods provider to accept the micro-payment intended for the first goods provider toward the good offered by the second goods provider.

3. The method as recited in claim 2, wherein forming the contract further includes contracting a conversion rate and revenue sharing between a first micro-payment denomination of the micro-payment issuer and a second micro-payment denomination accepted by the second goods provider.

4. The method as recited in claim 1, further comprising tracking the micro-payments redeemed by the second goods provider and invoicing the micro-payment issuer an amount of money.

5. The method as recited in claim 1, wherein the micro-payment is selected from the group of micro-payments consisting of: a bonus point, a referral point, a participation point, a purchase point, a reward point, a thank you point, an airline mile, a mobile phone minute, a coupon discount, a promotional discount, a discount code, a virtual coin, a hyperlink referral credit, and an online bonus credited for purchasing online.

6. The method as recited in claim 1, further comprising receiving from a user heterogeneous micro-payments of multiple micro-payment issuers; and
redeeming the heterogeneous micro-payments for a good offered by one of multiple goods providers.

7. The method as recited in claim 6, further comprising obtaining a set of contracts between pairs, each pair consisting of one of the micro-payment issuers and one of the goods providers;
each contract consisting at least in part of an agreement to accept a type of micro-payment of the micro-payment issuer for a type of good offered by the good provider; and
wherein a contract is not obtained when a micro-payment issuer of one of the pairs and a goods provider of the pair are the same entity.

8. The method as recited in claim 7, wherein the contracts specify a conversion rate for each of the heterogeneous micro-payments with respect to a standard.

9. The method as recited in claim 8, wherein the standard comprises a denomination of one of the micro-payments of one of the goods providers.

10. A clearinghouse, comprising:
contracts between points issuers and service providers, each contract an agreement to accept a type of point issued by the point issuer for a type of good offered by the service provider; and
a redemption engine to accept points of a first points issuer intended for a first type of goods of a first service provider to procure a second type of good of a second service provider.

11. The clearinghouse as recited in claim 10, wherein the points are selected from a group of points consisting of: referral points, participation points, purchase points, reward points, thank you points, airline miles, mobile phone minutes, coupon discounts, promotional discounts, discount codes, virtual coins, hyperlink referral credits, and online bonuses and discounts credited for purchasing online.

12. The clearinghouse as recited in claim 10, wherein the redemption engine converts a first value of points of a first points issuer into a second value of points of a second points issuer according to a conversion rate in one of the contracts.

13. The clearinghouse as recited in claim 10, wherein the redemption engine accepts heterogeneous points of multiple points issuers from a user of the clearinghouse to procure the good.

14. The clearinghouse as recited in claim 10, further comprising a user accounts manager to administer multiple point balances of a user.

15. The clearinghouse as recited in claim 14, wherein the user accounts manager prioritizes the multiple bonus point balances such that the highest priority balance is redeemed first when obtaining a good.

16. The clearinghouse as recited in claim 14, further comprising an invoicing engine to enable money flow between the points issuers, the service providers, and the clearinghouse according to the contracts.

17. A user interface, comprising:
a visual list of prioritized bonus point balances; and
a visual selector for designating one of the bonus point balances issued by a first service provider to redeem for a good offered by a second service provider.

18. The user interface as recited in claim 17, further comprising an input for entering information to add an additional bonus point balance issued by an additional service provider.

19. The user interface as recited in claim 17, further comprising an input for linking two of the bonus point balances such that a first of the two bonus point balances refills a second of the two bonus point balances according to a conversion rate when the second bonus point balance falls below a threshold.

20. The user interface as recited in claim 17, further comprising a visual option to buy a good using cash or to buy the good using bonus points, including a menu of heterogeneous bonus point balances to select for redeeming the good via one or more of the heterogeneous bonus point balances.
